(19) United States
(12) Patent Application Publication
(10) Pub. No.: US 2014/0168040 A1
(43) Pub. Date: Jun. 19, 2014

(54) MOTION COMPENSATED VIDEO HALFTONING

(71) Applicant: QUALCOMM MEMS TECHNOLOGIES, INC., San Diego, CA (US)

(72) Inventors: Behnam Bastani, Sunnyvale, CA (US); Muhammed Ibrahim Sezan, Los Gatos, CA (US); Alok Govil, Santa Clara, CA (US)

(73) Assignee: QUALCOMM MEMS Technologies, Inc., San Diego, CA (US)

(21) Appl. No.: 13/717,446

(22) Filed: Dec. 17, 2012

(51) Int. Cl. G09G 3/20

(52) U.S. Cl. CPC G09G 3/2003
USPC 345/84

(57) ABSTRACT

This disclosure provides systems, methods and apparatus, including computer programs encoded on computer storage media, for halftoning video images for presentation on an electronic display. In one aspect, input frames of video data may be received, where each input frame includes a number of input pixels, each input pixel having a respective first spatial coordinate location. For each input pixel, an output pixel is generated using a selected halftone value. The selected halftone value is substantially identical to a halftone value of a corresponding pixel in a comparison frame, where a spatial coordinate location of the “corresponding pixel” is determined based on a motion vector of an image element with which the pixel is associated.

### TECHNICAL FIELD

This disclosure relates to halftoning techniques, and, more specifically, to improved techniques for halftoning video frames for presentation on an electronic display.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Electronic displays may be required to render and present image data in real time that is received on a frame by frame basis by way, for example, of a broadcast or cellular network, or over the internet, at frame rates of, for example, 30 frames per second. Such digital images are typically encoded at a relatively high bit depth of 24 bits per pixel (bpp) for color images. However, many electronic displays (such as bi-level displays or multi-level displays with only a few levels) are only capable of rendering images with a substantially lower bit-depth. Some color reflective displays, such as analog electromechanical display devices, for example, may render images at a bit depth of two bits per color channel (6 bpp). A process called halftoning is used to reduce high bit-depth images (“continuous tone” or “contone” images) to images with a more limited number of tone levels. In general, halftoning is a process for creating, with a limited number of tone levels, the perception of a continuous tone color image using knowledge of the spatio-chromatic discrimination capabilities of the human visual system.

Known halftoning techniques suitable for real time applications such as electronic display of transmitted video content include error diffusion techniques such as, for example, Floyd Steinberg Error Diffusion (FSED). Because halftone textures are not ordinarily correlated along the temporal axis, applying FSED-based methods to video data can generate objectionable artifacts.

These objectionable artifacts may include temporal flickering or “boiling,” that are readily observable, particularly when the video frames contain both moving and static (non-moving) image content. The artifacts arise because, where each frame of a video is halftoned independently of the next frame, different spatial halftone patterns are produced through the FSED process. For example, when consecutive frames of static and moving image content are rendered, known error diffusion techniques may produce halftone patterns for static regions that are different frame to frame. The variable halftone pattern within static regions may result in observable artifacts such as moving dots and structures on the intended-to-be static background, referred to as boiling.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including an electronic display and a display control module. The display control module may be configured to receive input frames of video data, each input frame including input pixels for depicting one or more image elements, each image element characterized by a respective motion vector, each input pixel having a respective first spatial coordinate location. For each input frame, an output frame may be rendered on the electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame. For a first portion of the input frame that includes a first subset of input pixels that includes only input pixels associated with image elements having a motion vector of zero, and a second subset of the input pixels that includes only input pixels associated with image elements having a non-zero motion vector. For each input pixel in the first subset of input pixels, the corresponding pixel in the comparison frame has a respective second spatial coordinate location identical to the respective first spatial coordinate location. For each input pixel in the second subset of input pixels, the corresponding pixel in the comparison frame has a respective third spatial coordinate location offset from the respective first spatial coordinate location, the spatial coordinate location offset being determined by the non-zero motion vector.

In some implementations, a second portion of the input frame may include a third subset of the input pixels different from the first subset and the second subset, and the display control module may be further configured to determine a respective halftone value for each of the third subset of input pixels using an error diffusion technique.

In some implementations, the respective motion vectors of the image elements may be known a priori. For example, information of the motion vectors may be pre-identified by a content provider or by one or more of the operating system and the processor.

In some implementations, the spatial coordinate location offset for each of the second subset of input pixels may correspond to a direction and a distance indicated by the non-zero motion vector.

In some implementations, the comparison frame may be an adjacent, or nearly adjacent, frame of data preceding or subsequent to the input frame.

In some implementations, the display control module may be further configured to generate a halftone pattern of a static background image once and statically apply the halftone pattern from frame to frame.

In some implementations, the display control module may be configured to calculate the respective motion vector of the image elements from frame to frame.

In some implementations, when the input pixel is proximate to an edge of an image element, the display control module may be further configured to compute the respective halftone value of the input pixel by applying an error diffusion technique to the input pixel.

In some implementations, the display control module is further configured to determine the halftone value of one or more of the corresponding pixels in the comparison frames by applying an error diffusion technique

Another innovative aspect of the subject matter described in this disclosure can be implemented in an apparatus comprising an electronic display and a display control module. The display control module may be configured to receive a plurality of input frames of video data, each input frame including a plurality of input pixels depicting one or more image elements, each image element characterized by a respective motion vector. The apparatus may further include means for generating, for each input pixel, an output pixel using a selected halftone value, the input pixel having a first spatial coordinate location, the selected halftone value being substantially identical to a halftone value of a corresponding pixel in a comparison frame; and for rendering each output frame on the electronic display to form a displayed halftone image. A first subset of the input pixels may include only input pixels associated with image elements having a motion vector of zero, and, for each input pixel in the first subset of input pixels, the corresponding pixel in the comparison frame may have a second spatial coordinate location identical to the first spatial coordinate location. A second subset of the input pixels may include only input pixels associated with image elements having a non-zero motion vector. For each input pixel in the second subset of input pixels, the corresponding pixel in the comparison frame may have a third spatial coordinate location offset from the first spatial coordinate location, the spatial coordinate location offset being selected to correspond with the non-zero motion vector.

Another innovative aspect of the subject matter described in this disclosure can be implemented in a method to halftone video data for an electronic display. The method may include receiving a plurality of input frames of video data, each input frame including a plurality of input pixels that depicts one or more image elements, each image element characterized by a respective motion vector, each input pixel having a respective first spatial coordinate location, and for each input frame, rendering an output frame on the electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame. A first portion of the input frame may include a first subset of input pixels that includes only input pixels associated with image elements having a motion vector of zero, and a second subset of the input pixels that includes only input pixels associated with image elements having a non-zero motion vector. For each input pixel in the first subset of input pixels, the corresponding pixel in the comparison frame may have a respective second spatial coordinate location identical to the respective first spatial coordinate location. For each input pixel in the second subset of input pixels, the corresponding pixel in the comparison frame may have a respective third spatial coordinate location offset from the respective first spatial coordinate location, the spatial coordinate location offset being determined by the non-zero motion vector.

Another innovative aspect of the subject matter described in this disclosure can be implemented in a computer-readable storage medium having stored thereon instructions which, when executed by a computing system, cause the computing system to perform operations, the operations including: receiving a plurality of input frames of video data, each input frame including a plurality of input pixels that depicts one or more image elements, each image element characterized by a respective motion vector, each input pixel having a respective first spatial coordinate location; and, for each input frame, rendering an output frame on an electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame. For a first portion of the input frame that includes a first subset of input pixels that includes only input pixels associated with image elements having a motion vector of zero, and a second subset of the input pixels that includes only input pixels associated with image elements having a non-zero motion vector, for each input pixel in the first subset of input pixels, the corresponding pixel in the comparison frame may have a respective second spatial coordinate location identical to the respective first spatial coordinate location. For each input pixel in the second subset of input pixels, the corresponding pixel in the comparison frame may have a respective third spatial coordinate location offset from the respective first spatial coordinate location, the spatial coordinate location offset being determined by the non-zero motion vector.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 shows an example of a block diagram of an apparatus including an electronic display and a display control module.

FIG. 8 shows an example of a block diagram of an apparatus for rendering an image on an electronic display.

FIG. 9 shows an example of how temporal flicker may be produced by an error diffusion halftoning technique.

FIG. 10 illustrates an example of image data to which the presently disclosed techniques may be applied.

FIG. 11 illustrates an example of a motion vector map for the image data example of FIG. 10.

FIG. 12 illustrates an example of a conceptual data flow diagram of one implementation of a method for halftoning video data in accordance with an implementation.

FIGS. 13A-B show an example of a method for halftoning video data in accordance with an implementation.

FIGS. 14A and 14B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques for halftoning video frames. Where the frames include one or more image element having associated motion vectors, a halftone value of pixels associated with the image element may be determined by applying knowledge of the motion vector information to halftone values for pixels of a comparison frame, thereby producing a motion compensated halftone pattern. More particularly, for areas of an input frame corresponding to image elements having a motion vector of zero, halftone values from the comparison frame may be applied to corresponding pixels of the new frame. As a result, boiling in static regions of the image may be prevented.

For areas of the input frame corresponding to image elements having a respective non-zero motion vector, halftone patterns may be moved in a direction and distance determined by the respective motion vector. Because of this, no new pattern need be created frame to frame for the moving object and the process likewise reduces or avoids boiling in the moving image elements.

Particular implementations of the subject matter described in this disclosure can be implemented to realize one or more of the following potential advantages. The presently disclosed video halftoning techniques substantially prevent objectionable visual artifacts that arise, in the absence of the present teachings, when each frame of a video is halftoned independently of the next frame. Further, an increase in frame update rate may be achieved by the disclosed techniques, because, a new halftone pattern may need to be generated only for areas on the frame where content is new. For example, when an image region is stationary, updating of pixels in that image region may be avoided, with a consequential reduction in frame updating time. Similarly, when a foreground image element having fixed content is in motion calculating new halftone data for at least a substantial part of the image element may be avoided.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

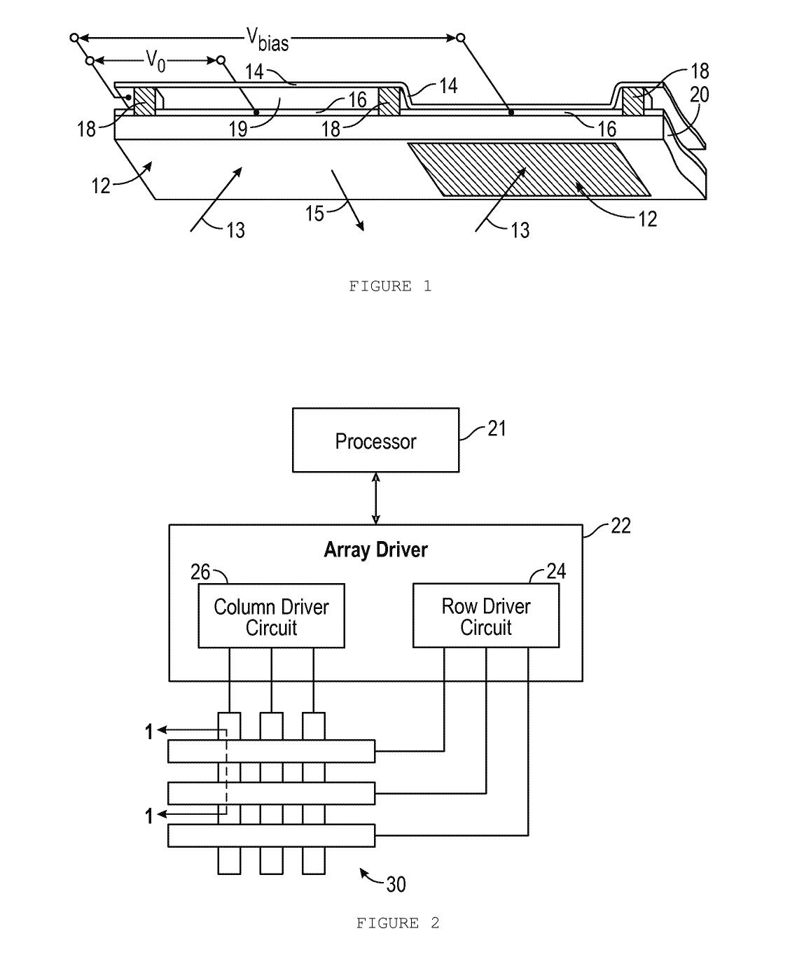

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

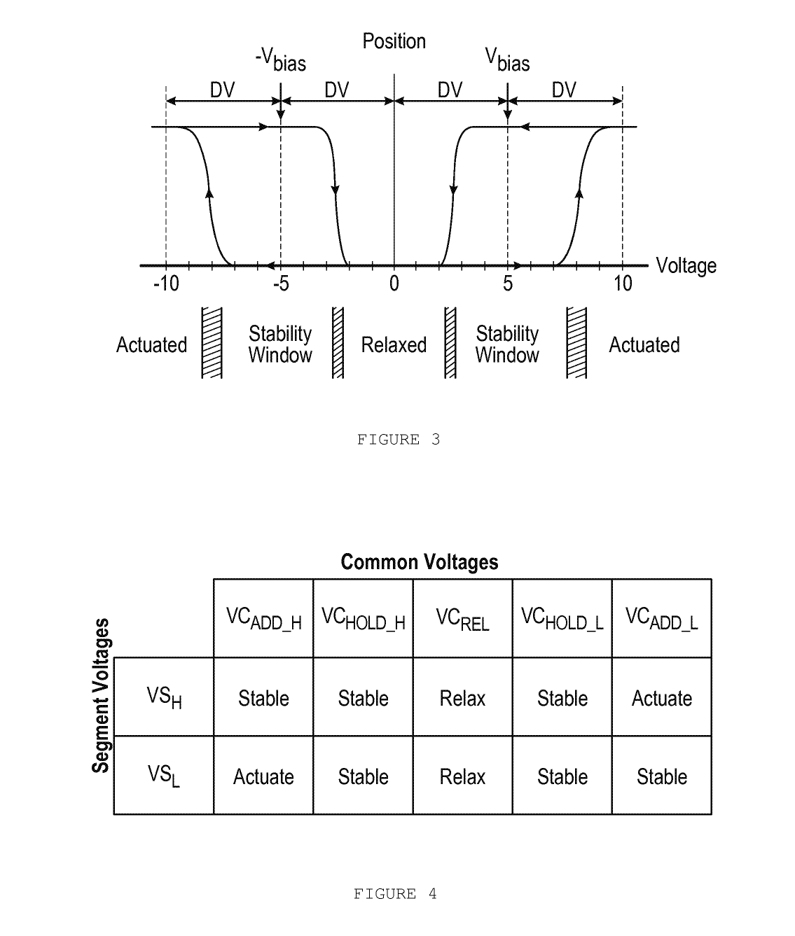

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

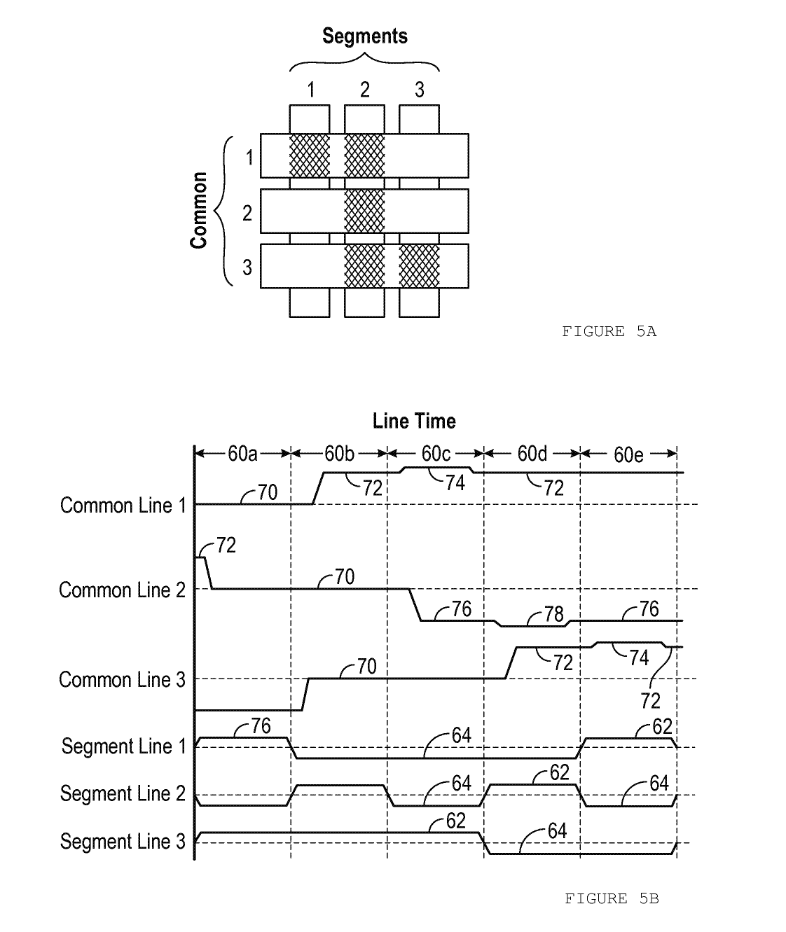

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

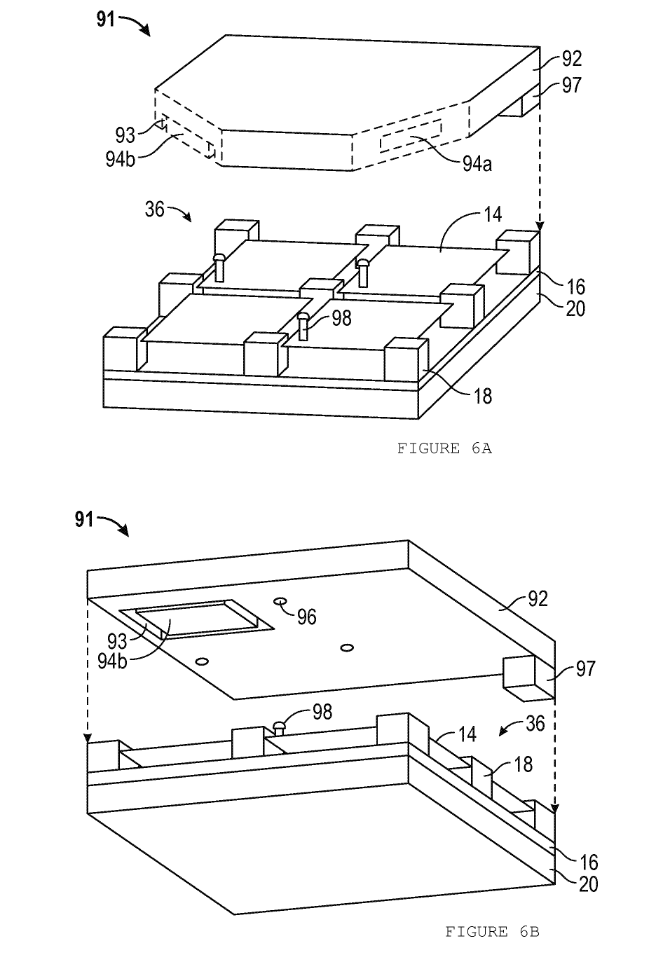

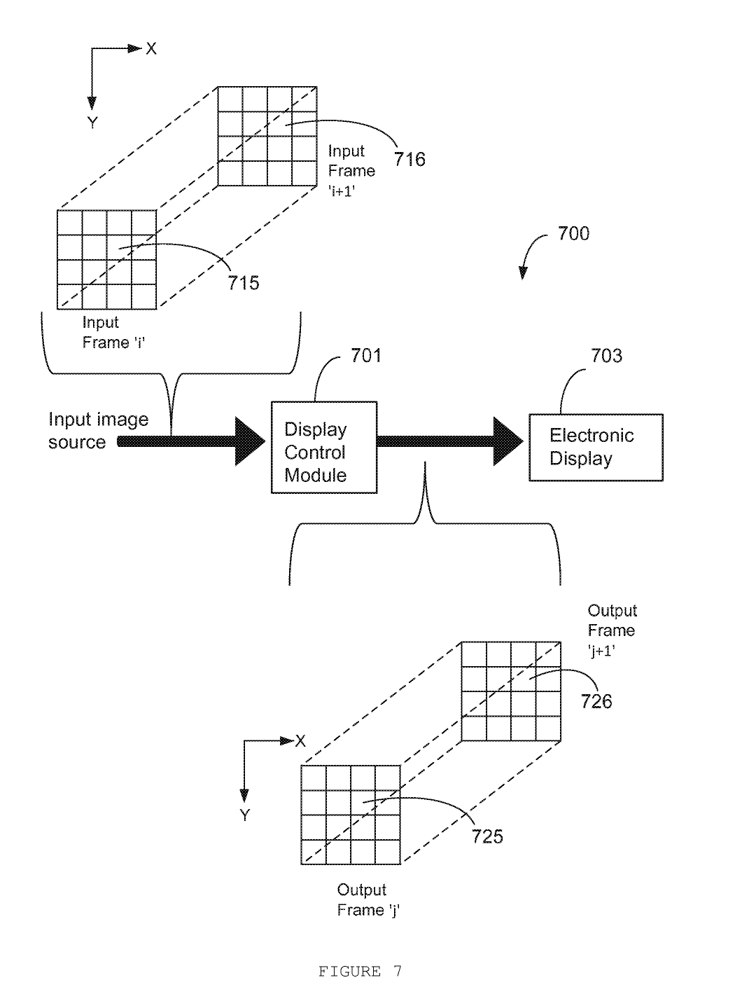

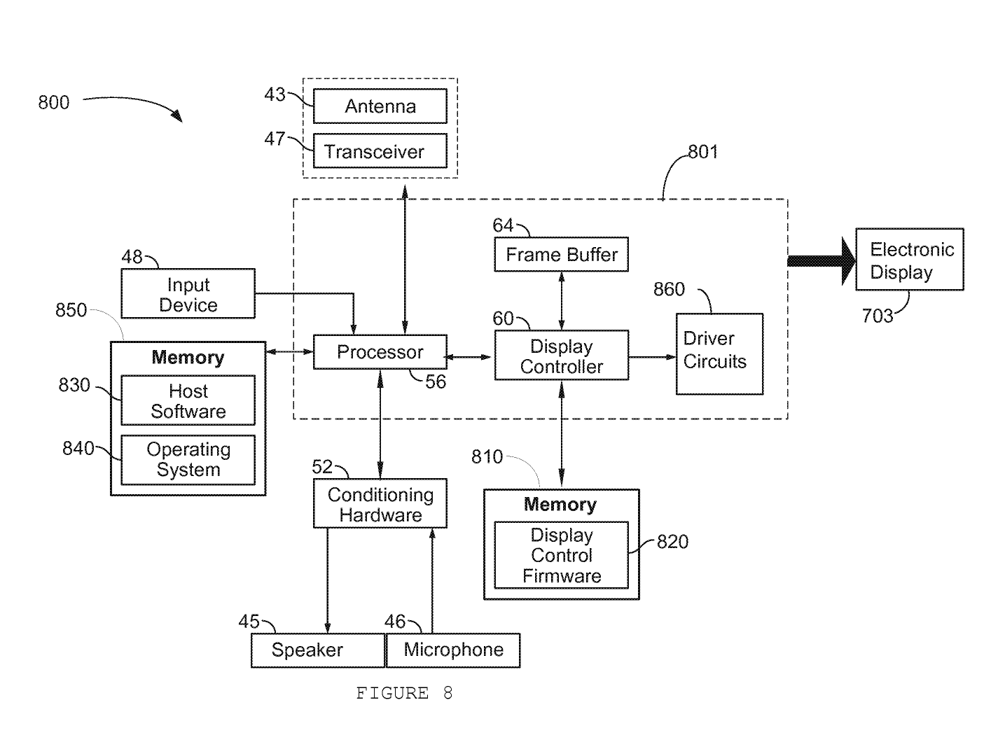

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

FIG. 7 shows an example of a block diagram of an apparatus including an electronic display and a display control module. In the illustrated implementation, apparatus 700 includes electronic display 703 and display control module 701. Display control module 701 may be configured to receive input frames of video data from an input image source. The input image source may include another component of the apparatus, such as, for example a memory or input device of the apparatus. In addition, or alternatively, the input image source may be partly or entirely external to the apparatus. For example, the input image source may be coupled to the apparatus by a broadcast or cellular network, or the Internet.

Display control module 701 may be configured to render, on electronic display 703, an output frame of video data, such that electronic display 703 is caused to display a halftoned image corresponding to the input frame of video data. More particularly, display control module 701 may receive a plurality of input frames, on a frame by frame basis, for example, where each input frame includes a set of input pixels. Display control module 701 may be configured to generate, for each input frame, an output frame of video data, the output frame of video data including halftoned output pixels generated using a halftoning technique described in more detail herein below. As a result, an input video stream of sequential frames of continuous tone pixels may be converted to an output video stream of sequential frames of halftoned pixels.

Each pixel in a frame may have a spatial coordinate location defined by its spatial (x, y) coordinates within the frame, and by its temporal coordinates, which may be defined by frame number. For example, referring still to FIG. 7, pixel 715 in input frame ‘i’ may be identified as (3, 2, i). Pixel 725 in output frame ‘j’, located at the same spatial (x, y) coordinate, may be said to correspond to pixel 715, and be identified as (3, 2, j). Similarly, pixel 726 in output frame ‘j+1’ may be identified as (3, 2, j+1) and be said to correspond to pixel 716 (3, 2, i+1).

FIG. 8 shows an example of a block diagram of an apparatus for rendering an image on an electronic display. Apparatus 800 includes electronic display 703 and display control module 801. As illustrated, display control module 801 may include processor 56, frame buffer 64, display controller 60 and driver circuits 860. Display control module 801, accordingly, is a particular implementation of display control module 701 illustrated in FIG. 7. Processor 56 may be in communication with a memory 850. The memory 850 may include host software 830 and operating system 840. Processor 56 may also be in communication with display controller 60. Display controller 60 may be in communication with a frame buffer 64 and a memory 810. Memory 810 may include display control firmware 820.

In some implementations, instructions within operating system 840 may manage the resources of apparatus 800 to accomplish particular functions of apparatus 800. For example, operating system 840 may manage resources such as speaker 45 and microphone 46, as well as antenna 43 and transceiver 47. Operating system 840 may also include display device drivers that manage electronic display 703, such as a display controlled by display controller 60. A display device driver within operating system 840 may include instructions that render an image on an electronic display.

For example, instructions within operating system 840 may render an image on electronic display 703. Operating system 840 may further include instructions that configure the processor 56 to receive input frames of video data, each input frame including a set of pixels.

In other implementations, the functions described above as included in operating system 840 may instead be included in host software 830. Alternatively, these functions may instead be implemented by instructions included in display control firmware 820. In still other implementations, these functions may be implemented in special purpose circuits. It will be appreciated that other implementations that may vary from the block diagram of FIG. 8 are within the contemplation of the present disclosure. Furthermore, it should be noted that the presently disclosed techniques are applicable to electronic displays of many types and are generally advantageous to any electronic display that renders images at relatively low bit depth. Such displays may include hand held devices such as personal digital assistants and e-readers, as well as electronic billboards, for example.

One aspect of the present disclosure relates to avoiding temporal flickering or “boiling” that may result from applying error diffusion halftoning methods to video data. Accordingly, a better understanding of the present disclosure may result from describing this phenomenon in more detail. Boiling occurs when a stationary object in a video sequence is rendered with different halftone patterns in the corresponding halftone sequence. Halftone images generated by conventional Floyd-Steinberg error diffusion are particularly susceptible to boiling.

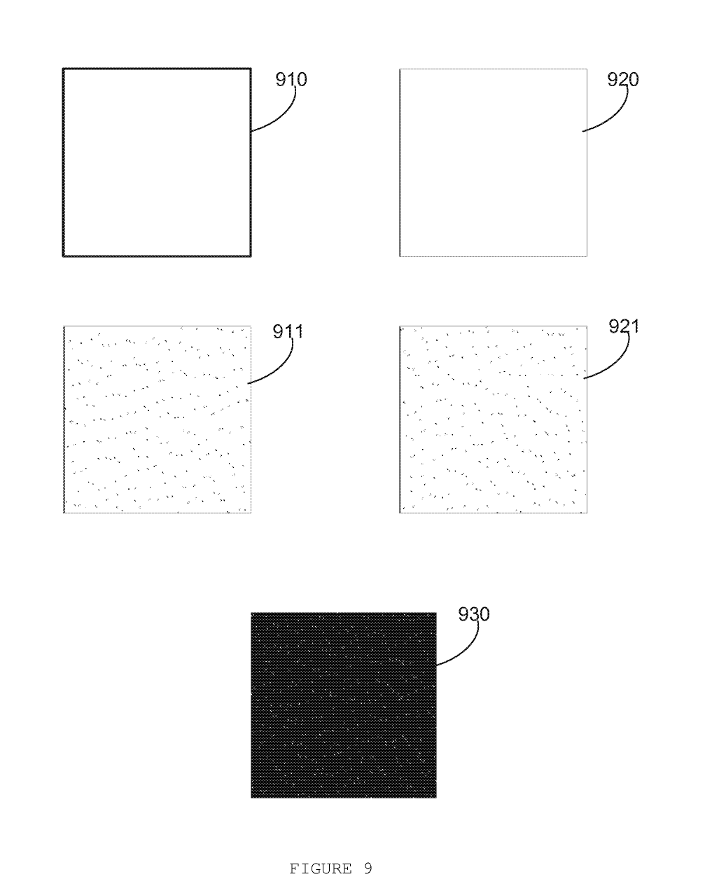

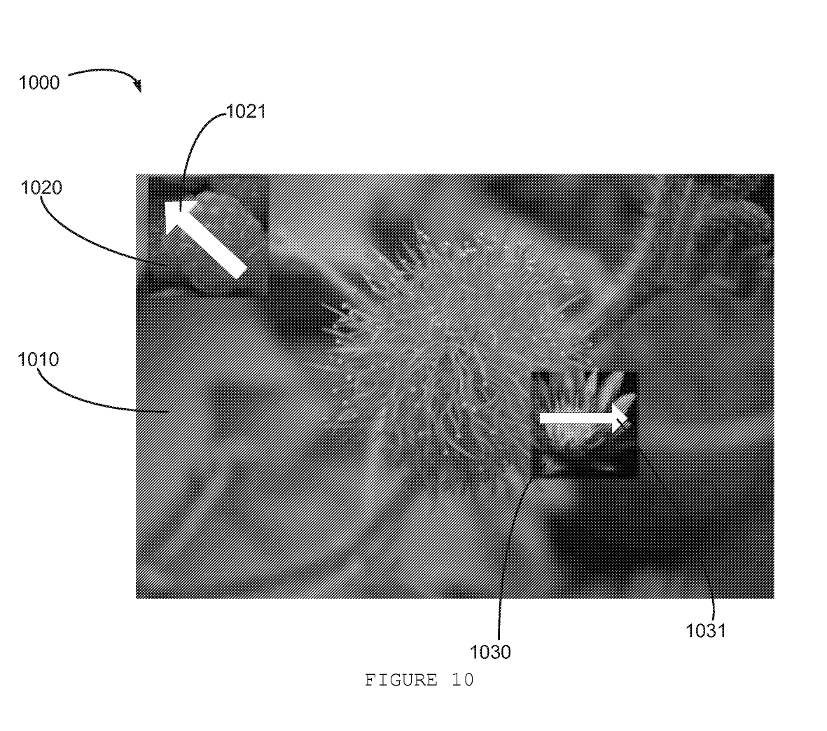

FIG. 9 shows an example of how temporal flicker may be produced by an error diffusion halftoning technique. Images 910 and 920, while giving the visual impression of being identical, are actually different input images to the error diffusion technique, which each resulted from adding a very small amount of uniform random noise to a constant tone image, which is a white image in the current example. Images 911 and 921 are halftoned images of, respectively, images 910 and 920. Image 930 illustrates the difference between images 911 and 921. This difference is what the human visual system can perceive as boiling, an objectionable visual artifact. To reduce boiling, a temporal correlation of at least portions of an image data frame can be advantageously used in some implementations.

In one implementation, input frames of video data may be received, where each input frame includes a number of input pixels, each input pixel having a respective first spatial coordinate location. For each input pixel, an output pixel may be generated using a selected halftone value. Advantageously, the selected halftone value may be substantially identical to a halftone value of a corresponding pixel in a comparison frame. A spatial coordinate location of the “corresponding pixel” may be determined based on a motion vector of an image element with which the pixel is associated. The “comparison frame” may be an adjacent or nearly adjacent frame. For example the comparison frame may be an immediately preceding frame, an immediately subsequent frame, or a preceding or subsequent frame a few frames separated from the input frame.

More particularly, in one implementation, for a first subset of the input pixels that includes only input pixels associated with image elements having a motion vector of zero, for each input pixel in the first subset of input pixels the corresponding pixel in the comparison frame has a respective second spatial coordinate location identical to the respective first spatial coordinate location. For a second subset of the input pixels that includes only input pixels associated with image elements having a non-zero motion vector, for each input pixel in the second subset of input pixels the corresponding pixel in the comparison frame has a respective third spatial coordinate location offset from the respective first spatial coordinate location, the spatial coordinate location offset being determined with reference to the non-zero motion vector.

The respective motion vector of an image element may be known a priori, or may be calculated on a frame by frame basis.

FIG. 10 illustrates an example of image data to which the presently disclosed techniques may be applied. In the illustrated example, a frame 1000 of image data includes a static background image 1010, first foreground image element 1020 and second foreground image element 1030. In the illustrated example, foreground image elements 1020 and 1030 move from frame to frame with respect to the static background image in the directions illustrated by respective vectors 1021 and 1031. The respective motion vector for each foreground image element, and the fact that the background image is static (i.e. has a zero magnitude motion vector) may be known a priori, or may be determinable in real time. In an implementation, a respective halftone pattern for each foreground image element having a known or determinable motion vector may be initially created and then translated, from frame to frame, in a direction and at a rate corresponding to the image element's motion vector. A halftone pattern of the static background image may be created once and statically applied from frame to frame. In the illustrated example, therefore, halftoning values would have to be updated from frame to frame only for pixels at the trailing and leading edges of the foreground image elements.

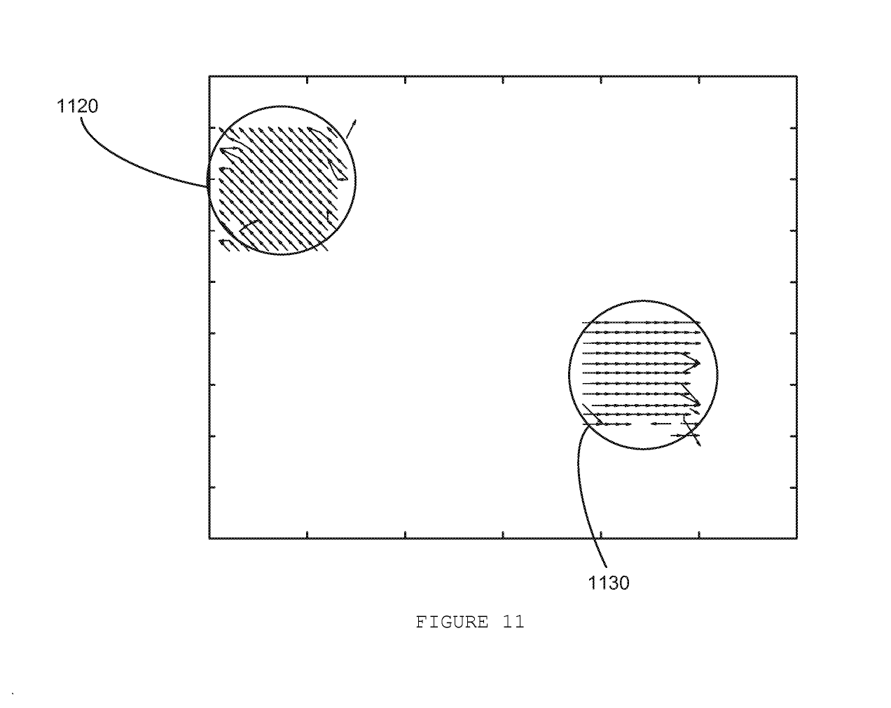

In an implementation, motion vectors for one or more image elements are obtained or calculated from frame to frame. For example, FIG. 11 illustrates an example of a motion vector map for the image data example of FIG. 10. In the illustrated example, motion vectors 1120 relate to image element 1020 of FIG. 10, whereas motion vectors 1130 relate to image element 1030 of FIG. 10.

Motion vector information such as that illustrated by motion vectors 1120 and 1130 is often available a priori. For example, motion vector information may be pre-identified by, for example, a content provider for data compression purposes. Moreover, many display and cell phone processing chips estimate image element motion for encoding purposes. As a further example, a device processor and/or operating system may inherently have knowledge of and/or control over a motion of one or more components in a displayed image, for example, an icon.

For an image element having an associated motion vector, a halftone value of pixels associated with the image element may be determined by applying knowledge of the motion vector information to halftone values for pixels of a comparison frame, thereby producing a motion compensated halftone pattern. More particularly, for areas of an input frame corresponding to image elements having a motion vector of zero, halftone values from the comparison frame may be applied to corresponding pixels of the new frame. As a result, boiling in static regions of the image may be prevented.

For areas of the input frame corresponding to image elements having a respective non-zero motion vector, halftone patterns may be moved in a direction and distance determined by the respective motion vector. Because of this, no new pattern need be created frame to frame for the moving object and the process likewise reduces or avoids boiling in the moving image elements.

Advantageously, a new halftone pattern may be generated only for areas on the frame where content is new or has moved, for example, where regions of a background image that were occluded by a foreground image element in a preceding frame become visible in a subsequent frame. To remove any transition error on the edge of new and existing regions, an error map of the previous frame halftone image may be used. The error map may record errors that each pixel diffused to neighboring pixels during spatial halftoning, for example.

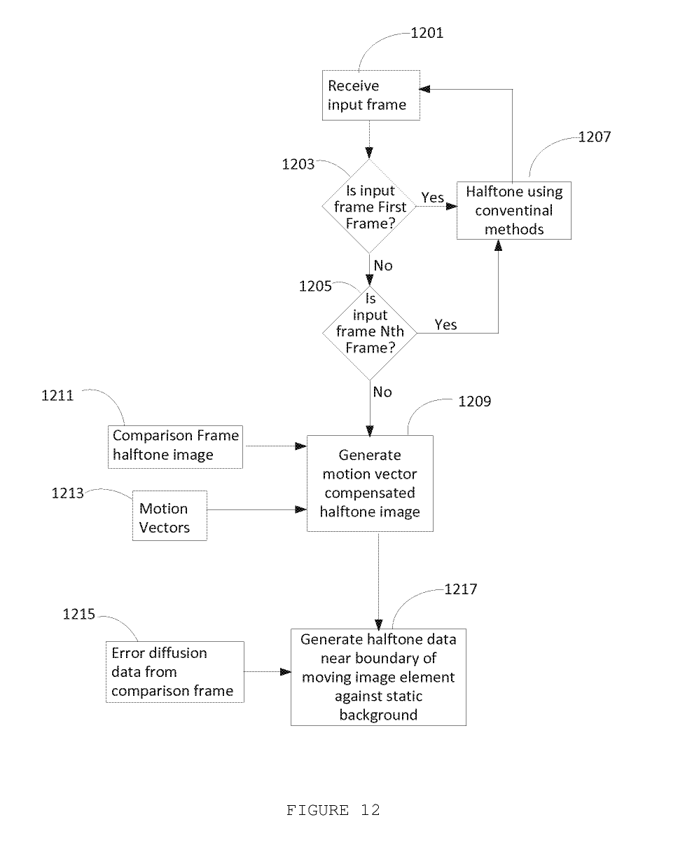

FIG. 12 illustrates an example of a conceptual data flow diagram of one implementation of a method for halftoning video data in accordance with an implementation. At block 1201, an input frame of data may be received. Each input frame may include data for a number of input pixels. The input pixel data may be encoded at a high bit depth, for example at 24 bpp. If the input frame is determined, at block 1203, to be a first frame in a sequence, halftoning of the frame may be carried out using conventional methods at block 1207. For example an error diffusion technique may be implemented, such as Floyd Steinberg error diffusion.

Similarly, halftoning may be performed on a periodic basis, for example, it may be performed after each interval of ‘N’ frames, where N is an integer, for example, 10 or 20. Then, a determination may be made at block 1205 whether the input frame is an ‘Nth’ frame in the sequence, by which is meant that ‘N’ frames have been received since the last occasion on which process block 1207 was executed. If the determination is made that the input frame is an Nth frame, halftoning of the frame may be carried out using conventional methods at block 1207, otherwise the process may proceed to block 1209. The value of N may be adaptive depending on the content. Smooth (flat field) content may require very careful halftoning and any non-perfection may leave residuals that are objectionable and thus require small values for N (around 10, for example). On the other hand, content that has more spatially complex data, may have larger N values (around 20, for example).

When it is determined that the input frame is neither the first frame in the sequence, nor an Nth frame, a motion vector compensated halftone image may be generated at block 1209 for at least a portion of the input frame. Advantageously, the portion of the input frame will be static with respect to a corresponding portion of a comparison frame, or will have a known or determinable non-zero motion vector with respect to that corresponding portion.

Block 1209 may generate motion vector compensated halftone images from an input frame of data by using halftone image data from a comparison frame, and motion vector information associated with at least the portion of the comparison frame. More particularly, comparison frame halftone image block 1211 and motion vectors block 1213 may be inputs to block 1209. The comparison frame may be an adjacent, or nearly adjacent, frame of data preceding or following the input frame.

The motion vector information of block 1213 may relate to elements having a known or determinable, zero or non-zero rate of motion from frame to frame. In an implementation, block 1209 may generate the motion compensated halftone image by generating a number of output pixels. Each output pixel may be generated from a respective input pixel using a respective halftone value. For a first portion of the input frame, each respective halftone value may be substantially identical to a halftone value of a corresponding pixel in a comparison frame. The first portion of the input frame may include (i) a first subset of the input pixels that includes only input pixels associated with image elements having a motion vector of zero, and (ii) a second subset of the input pixels that includes only input pixels associated with image elements having a non-zero motion vector. For each input pixel in the first subset of input pixels, the corresponding pixel in the comparison frame may have a respective second spatial coordinate location identical to the respective first spatial coordinate location. For each input pixel in the second subset of input pixels, on the other hand, the corresponding pixel in the comparison frame may have a respective third spatial coordinate location offset from the respective first spatial coordinate location. The spatial coordinate location offset may be determined by the non-zero motion vector. For example, the spatial coordinate location offset may correspond to the direction and distance indicated by the motion vector.

An output of block 1209 may be further processed at block 1217. In an implementation, for example, halftone image data at a boundary of an image element that moves from frame to frame with respect to a background image, may be generated using error diffusion data from the comparison frame. For example, a new halftone pattern may be generated where regions of a background image that were occluded by a foreground image element in a preceding frame become visible in a subsequent frame. To reduce transition error on the edge of moving image elements, an error map of the previous frame halftone image may be used.

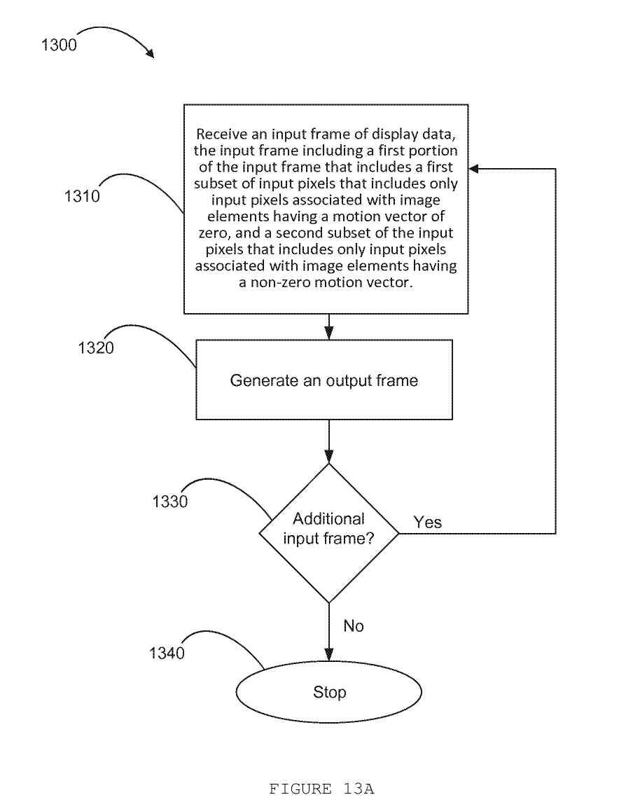

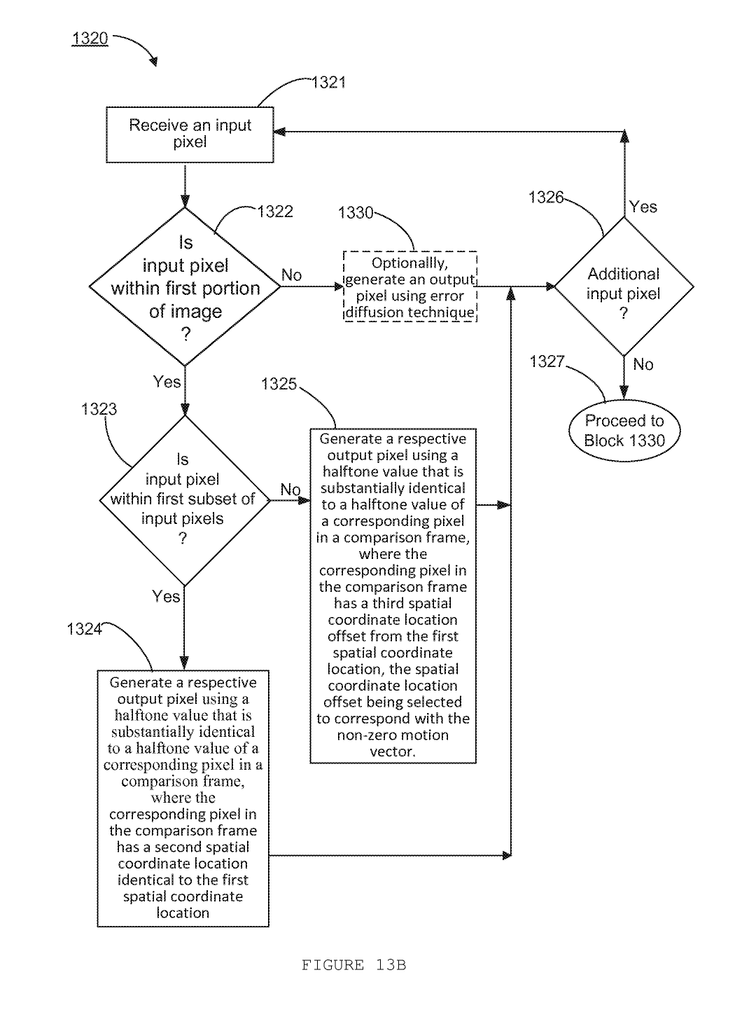

FIGS. 13A-B show an example of a method for halftoning video data in accordance with an implementation. Referring first to FIG. 13A, in an implementation, halftoning method 1300 may be performed by display control module 701 or 801 as depicted, respectively, in FIG. 7 and FIG. 8.

The method may begin at block 1310 with receiving an input frame of video data, the input frame including a plurality of input pixels. The input frame may be received from another component of an apparatus including an electronic display, such as, for example a memory or input device of the apparatus. In addition, or alternatively, the source of the input frame may be external to the apparatus. For example, the input image source may be coupled to the apparatus by a broadcast or cellular network, or the Internet. The input frame may include a first portion of the input frame that includes a first subset of input pixels that includes only input pixels associated with image elements having a motion vector of zero, and a second subset of the input pixels that includes only input pixels associated with image elements having a non-zero motion vector. Each input pixel may have a respective first spatial coordinate location

At block 1320, an output frame of video data may be generated. The output frame may include halftoned output pixels, generated in accordance with a method illustrated in FIG. 13B.

At block 1330, a determination may be made whether an additional input frame remains to be processed. If there is at least one additional input frame remaining to be processed, the process may return to block 1310. If there is no additional input frame to be processed, the process may stop at block 1340.

Referring now to FIG. 13B, a more detailed illustration of process block 1320 will be described.

At block 1321 an input pixel may be received, the input pixel having a first spatial coordinate location. The input pixel may be one of a number of pixels associated with a common input frame. At block 1322, a decision may be made as to whether the input pixel is within a first portion an image. The first portion may include (i) a first subset of the input pixels that includes only input pixels associated with image elements having a motion vector of zero, and (ii) a second subset of the input pixels that includes only input pixels associated with image elements having a non-zero motion vector. Advantageously, the first portion may include only input pixels of the first subset and the second subset.

The input pixel may be determined not to be within the first portion of the image when, for example, it is not associated with an image element that has a known or determinable velocity vector. In such case, in some implementations, an output pixel may be generated, block 1330, from the input pixel data using an error diffusing technique.

When it is determined that the input pixel is within the first portion of the image, a determination may be made at block 1323 whether or not the input pixel is within the first subset of the input pixels that includes only input pixels associated with image elements having a motion vector of zero.

When the input pixel is determined, at block 1323, to be within the first subset of the input pixels that includes only input pixels associated with image elements having a motion vector of zero, a respective output pixel may be generated at block 1324, using a halftone value that is substantially identical to a halftone value of a corresponding pixel in a comparison frame, the corresponding pixel having a second spatial coordinate location identical to the first spatial coordinate location.

When the input pixel is determined, at block 1323, to not be within the first subset of the input pixels that includes only input pixels associated with image elements having a motion vector of zero, a respective output pixel may be generated at block 1325, using a halftone value that is substantially identical to a halftone value of a corresponding pixel in a comparison frame, where the corresponding pixel in the comparison frame has a third spatial coordinate location offset from the first spatial coordinate location, the spatial coordinate location offset being selected to correspond with the non-zero motion vector. The comparison frame may be an adjacent, or nearly adjacent, frame of data preceding or subsequent to the input frame.

At block 1326, a determination may be made whether an additional input pixel remains to be processed. If yes, the process may return to block 1321. If no, the process may be directed, at block 1327 to return to block 1330 in FIG. 13A.

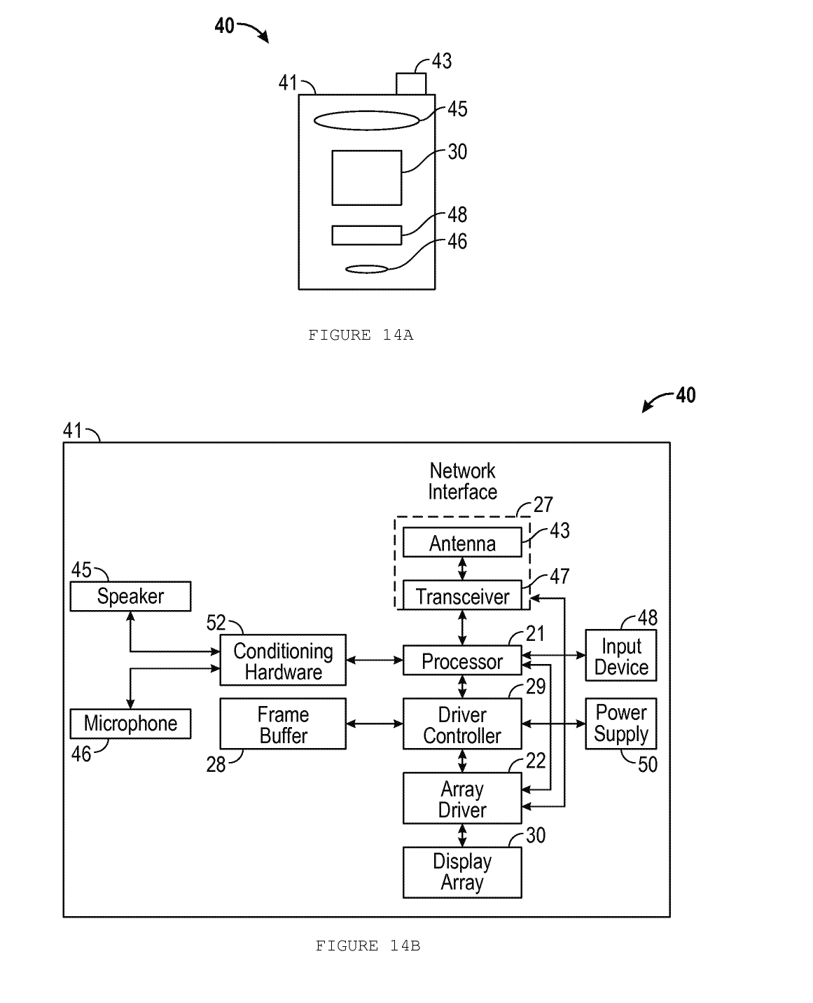

FIGS. 14A and 14B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single—or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an electronic display; and
a display control module, the display control module configured to:
receive a plurality of input frames of video data, each input frame including a plurality of input pixels that depicts one or more image elements, each image element characterized by a respective motion vector, each input pixel having a respective first spatial coordinate location;
for each input frame, render an output frame on the electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame, wherein:
for a first portion of the input frame that includes a first subset of input pixels that includes only input pixels associated with image elements having a motion vector of zero, and a second subset of the input pixels that includes only input pixels associated with image elements having a non-zero motion vector;
for each input pixel in the first subset of input pixels, the corresponding pixel in the comparison frame has a respective second spatial coordinate location identical to the respective first spatial coordinate location; and
for each input pixel in the second subset of input pixels, the corresponding pixel in the comparison frame has a respective third spatial coordinate location offset from the respective first spatial coordinate location, the spatial coordinate location offset being determined by the non-zero motion vector.

2. The apparatus of claim 1, wherein a second portion of the input frame includes a third subset of the input pixels different from the first subset and the second subset, and wherein the display control module is further configured to determine a respective halftone value for each of the third subset of input pixels using an error diffusion technique.

3. The apparatus of claim 1, wherein the respective motion vectors of the image elements are known a priori.

4. The apparatus of claim 3, wherein information of the motion vectors is pre-identified by a content provider.

5. The apparatus of claim 3, further comprising one or more of an operating system and a processor, wherein information of the motion vectors is pre-identified by one or more of the operating system and the processor.

6. The apparatus of claim 1, wherein the spatial coordinate location offset for each of the second subset of input pixels corresponds to a direction and a distance indicated by the non-zero motion vector.

7. The apparatus of claim 1, wherein the comparison frame is an adjacent, or nearly adjacent, frame of data preceding or subsequent to the input frame.

8. The apparatus of claim 1, wherein the display control module is further configured to generate a halftone pattern of a static background image once and statically apply the halftone pattern from frame to frame.

9. The apparatus of claim 1, wherein the display control module is configured to calculate the respective motion vector of the image elements from frame to frame.

10. The apparatus of claim 1, wherein, when the input pixel is proximate to an edge of an image element, the display control module is further configured to compute the respective halftone value of the input pixel by applying an error diffusion technique to the input pixel.

11. The apparatus of claim 1, wherein the display control module is further configured to determine the halftone value of one or more of the corresponding pixels in the comparison frames by applying an error diffusion technique.

12. The apparatus of claim 1, further comprising:
a processor that is configured to communicate with the electronic display, the processor being configured to process image data; and
a memory device that is configured to communicate with the processor.

13. The apparatus of claim 12, further comprising:
a driver circuit configured to send at least one signal to the electronic display; and
a controller configured to send at least a portion of the image data to the driver circuit.

14. The apparatus of claim 12, further comprising:
an image source module configured to send the image data to the processor, wherein the image source module comprises at least one of a receiver, transceiver, and transmitter.

15. The apparatus of claim 12, further comprising:
an input device configured to receive input data and to communicate the input data to the processor.

16. An apparatus comprising:
an electronic display;
a display control module, the display control module configured to receive a plurality of input frames of video data, each input frame including a plurality of input pixels depicting one or more image elements, each image element characterized by a respective motion vector; and
means for:
generating, for each input pixel, an output pixel using a selected halftone value, the input pixel having a first spatial coordinate location, the selected halftone value being substantially identical to a halftone value of a corresponding pixel in a comparison frame; and
rendering each output frame on the electronic display to form a displayed halftone image;
wherein:
a first subset of the input pixels includes only input pixels associated with image elements having a motion vector of zero, and, for each input pixel in the first subset of input pixels, the corresponding pixel in the comparison frame has a second spatial coordinate location identical to the first spatial coordinate location; and
a second subset of the input pixels includes only input pixels associated with image elements having a non-zero motion vector, and, for each input pixel in the second subset of input pixels, the corresponding pixel in the comparison frame has a third spatial coordinate location offset from the first spatial coordinate location, the spatial coordinate location offset being selected to correspond with the non-zero motion vector.

17. The apparatus of claim 16, wherein the respective motion vector is known a priori.

18. The apparatus of claim 16, wherein the respective motion vector is calculated from frame to frame.

19. The apparatus of claim 16, wherein a halftone pattern of a static background image is created once and statically applied from frame to frame.

20. The apparatus of claim 16, wherein, when the input pixel is proximate to an edge of an image element, the selected halftone value is computed by applying an error diffusion technique to a value of the input pixel.

21. A method to halftone video data for an electronic display, the method comprising:
receiving a plurality of input frames of video data, each input frame including a plurality of input pixels that depicts one or more image elements, each image element characterized by a respective motion vector, each input pixel having a respective first spatial coordinate location;
for each input frame, rendering an output frame on the electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame, wherein:
for a first portion of the input frame that includes a first subset of input pixels that includes only input pixels associated with image elements having a motion vector of zero, and a second subset of the input pixels that includes only input pixels associated with image elements having a non-zero motion vector;
for each input pixel in the first subset of input pixels, the corresponding pixel in the comparison frame has a respective second spatial coordinate location identical to the respective first spatial coordinate location; and
for each input pixel in the second subset of input pixels, the corresponding pixel in the comparison frame has a respective third spatial coordinate location offset from the respective first spatial coordinate location, the spatial coordinate location offset being determined by the non-zero motion vector.

22. The method of claim 21, wherein the respective motion vector is known a priori.

23. The method of claim 22, wherein motion vector information is preidentified by a content provider.

24. The method of claim 22, wherein the electronic display includes one or more of an operating system and a processor, and motion vector information is preidentified by one or more of the operating system and the processor.

25. A computer-readable storage medium having stored thereon instructions which, when executed by a computing system, cause the computing system to perform operations, the operations comprising:
receiving a plurality of input frames of video data, each input frame including a plurality of input pixels that depicts one or more image elements, each image element characterized by a respective motion vector, each input pixel having a respective first spatial coordinate location;
for each input frame, rendering an output frame on an electronic display so as to form a displayed halftone image, the output frame including a plurality of output pixels, each output pixel being generated from a respective input pixel using a respective halftone value, each respective halftone value is substantially identical to a halftone value of a corresponding pixel in a comparison frame wherein:
for a first portion of the input frame that includes a first subset of input pixels that includes only input pixels associated with image elements having a motion vector of zero, and a second subset of the input pixels that includes only input pixels associated with image elements having a non-zero motion vector;
for each input pixel in the first subset of input pixels, the corresponding pixel in the comparison frame has a respective second spatial coordinate location identical to the respective first spatial coordinate location; and
for each input pixel in the second subset of input pixels, the corresponding pixel in the comparison frame has a respective third spatial coordinate location offset from the respective first spatial coordinate location, the spatial coordinate location offset being determined by the non-zero motion vector.

26. The method of claim 25, wherein the respective motion vector is known a priori.

27. The method of claim 26, wherein motion vector information is preidentified by a content provider.

28. The method of claim 26, wherein the electronic display includes one or more of an operating system and a processor, and motion vector information is preidentified by one or more of the operating system and the processor.
